(19) United States
(12) Patent Application Publication
(10) Pub. No.: US 2009/0260028 A1
(43) Pub. Date: Oct. 15, 2009

(54) VIDEO BUFFER FOR USE IN ADVERTISEMENT DISPLAYS

(75) Inventors: William Dunn, Alpharetta, GA (US); David Williams, Canton, GA (US); Gerald Fraschilla, Snellville, GA (US)

Correspondence Address: STANDLEY LAW GROUP LLP, 6300 Riverside Drive, Dublin, OH, 43017, US

(73) Assignee: Manufacturing Resources International, Inc., Alpharetta, GA (US)

(21) Appl. No.: 12/422,037

(22) Filed: Apr. 10, 2009

Related U.S. Application Data
(60) Provisional application No. 61/043,967, filed on Apr. 10, 2008.

(51) Int. Cl. H04H 60/32; H04N 7/025

(52) U.S. Cl. 725/20; 725/32; 725/134

(57) ABSTRACT

A video buffer system and method for use with advertising display systems. Programming packets are stored at the video buffer and displayed in a continuous loop until the next programming packet has been received and stored. The video buffer system allows for displays to continuously display advertisements during data stream interruption or delay. The video buffer system also records the number of times an advertisement has been played to ensure accurate billing for the advertisement.

### CROSS-REFERENCE TO RELATED APPLICATIONS

This application claims priority to co-pending U.S. application Ser. No. 61/043,967 filed on Apr. 10, 2008, which is herein incorporated by reference in its entirety.

### TECHNICAL FIELD

Exemplary embodiments relate generally to video buffers. More particularly, embodiments relate to video buffers used in advertisement delivery systems to ensure continuous advertisement display.

### BACKGROUND AND SUMMARY OF THE EXEMPLARY EMBODIMENT(S)

Businesses are always looking for ways to maximize their advertising dollars. To maximize the money spent, businesses often advertise in highly populated areas or find locations that have a captive audience. This quest for a captive audience has resulted in advertisement to individuals at gas pumps, bathrooms, ticket lines, amusement parks, stadiums, and other indoor/outdoor restaurants or entertainment venues.

To take advantage of this captive audience, displays may be affixed near the audience location, which may be outdoors and even in direct sunlight. Modern displays can handle the thermodynamic challenges that outdoor displays provide. These displays provide the ability for businesses to get commercials or marketing campaigns in front of consumers where previously this was not possible.

The advertisement displays work similar to other displays. An audio or video signal is sent to the display which then projects images to the consumer. In advertisement displays, the audio and video signals may be recorded advertisements, commercials, or movie previews. To properly bill the businesses for this advertisement time, an accurate record of the commercials or advertisements played must be kept.

In some systems, the audio and video signals pass through a controller system before being distributed to the individual displays. The control unit keeps track of the each advertisement that is played, allowing for an accurate record to be kept. The audio and video signal may be transmitted from an offsite location or may be stored on site. The audio and video signal consists of packets of programming having a defined running time. The programming packet running time is defined by an embedded code at the beginning and end of each packet. The coding may provide information relating to the content of the programming packet, such as the advertisements contained therein, or other relevant information. The programming packets may further comprise a plurality of individual advertisements.

The plurality of individual advertisements may also have a defined running time. Optionally, this time may be defined by a code embedded in the audio/video signal at the beginning and end of the advertisement. This coding may contain an identifier unique to the advertiser.

The control unit uses the embedded coding at the beginning and end of the programming packet to determine the number of times an advertisement has been played on the displays, for billing purposes. After the signal has been read by the control unit, the audio and video signal is sent to the displays. The display units then respond by producing images to the customers at the gas pumps.

Although this system provides for an automated method of displaying advertisements and monitoring advertisements for billing purposes, several problems may arise in the use of these systems. If the audio/video signal is interrupted during transmission to the control unit, the displays may go blank and no audio/video signal is displayed to the customers. This ‘dead time’ would of course result in not being able to bill for advertisement time on the displays, and the customer would be paying for an expensive display and the accompanying advertising space while no materials were transmitted to the consumer.

Another problem that may occur using this system is a loss of audio and video signal between the control unit and the individual displays. Again, this type of outage would result in a blank screen on the affected displays, and a loss of advertisement revenue. In addition, the control unit has no way to determine the number of times certain advertisements have been shown in order to determine the correct billing amount. And likewise, businesses have no way of knowing if their advertisements were played the correct amount of times. Exemplary embodiments of the proposed system provide a method to ensure continuous, monitored, advertisement images on the individual displays.

To accomplish this, a video buffer may be located at each display unit. Instead of sending the audio and video signal directly to the display units, the control unit may send the signal to the video buffer. The video buffer reads the embedded codes at the beginning and end of the programming packet. The video buffer uses these embedded codes as markers for recording and distribution of the audio and video signal. When the video buffer reads the embedded code at the beginning of a programming packet it begins to record the programming packet. The video buffer continues to record until it receives and reads the embedded coding at the end of the programming packet. After reading the embedded code at the end of the packet, the video buffer may direct the display to play the programming packet, or may store the packet within a local storage device so that it can be played at a later time.

As the video buffer sends the first programming packet to the display, another programming packet may be transmitted to the video buffer. Thus, the video buffer is simultaneously sending the first programming packet to the display to be shown, while recording the second programming packet received from the control unit. The video buffer is programmed to loop the first programming packet until the second programming packet is fully recorded. Alternatively, the video buffer could play previously-stored packets until the next programming packet is fully recorded.

When the embedded code at the end of the second programming packet is received by the video buffer, the first programming packet may be displayed until the end of the current loop, and then may be purged from the video buffer memory, or saved locally. Then, the second programming packet may be sent to the display. To put it another way, the video buffer stores and displays a complete programming packet until the next complete programming packet is stored, at which time the first programming packet may be purged from memory and the second packet is sent for display. The video buffer continues to save and display in this manner for any number of programming packets. This method of playing only fully stored programming packets ensure that advertisements are displayed continuously to the customers during signal interruption to the control unit or individual displays.

As stated above, during a signal interruption, the control unit is unable to determine the number of times an individual advertisement has been shown on the displays or for how long. To accommodate for this deficiency, the video buffer may also have circuitry designed to record the number of times an individual programming packet has been looped or played. The video buffer uses the embedded coding at the beginning and end of the programming packets to determine which programming packet has been looped and stores this information in its memory. This stored memory may then be retrieved to determine what programming packets have actually been displayed. This ensures that an accurate count of the number of times an individual advertisement has been displayed may be retrieved and used for billing or other purposes.

In other embodiments, the video buffer may record the number of times an individual advertisement has been displayed by recording the embedded code at the beginning and end of the individual advertisements contained in the programming packet.

The video buffer may either be in wired or wireless communication with the control unit. In other exemplary embodiments, a control unit may not be used. In this embodiment, the video buffer records all the programming packets displayed.

Other systems, methods, features and advantages of the invention will be, or will become apparent to one skill in the art upon examination of the following figures and detailed description. It is intended that all such additional systems, methods, features, and advantages be included with this description and be within the scope of the invention.

### BRIEF DESCRIPTION OF THE DRAWING(S)

The exemplary embodiments may be better understood with reference to the following drawings and description. The components in the figures are not necessary to scale, emphasis instead being placed upon illustrating the principles of the invention. Moreover, in the figures, like referenced numerals designate corresponding parts throughout the different views.

FIG. 1 is a block diagram of an exemplary embodiment of the video buffer system.

### DETAILED DESCRITPION OF THE EXEMPLARY EMBODIMENT(S)

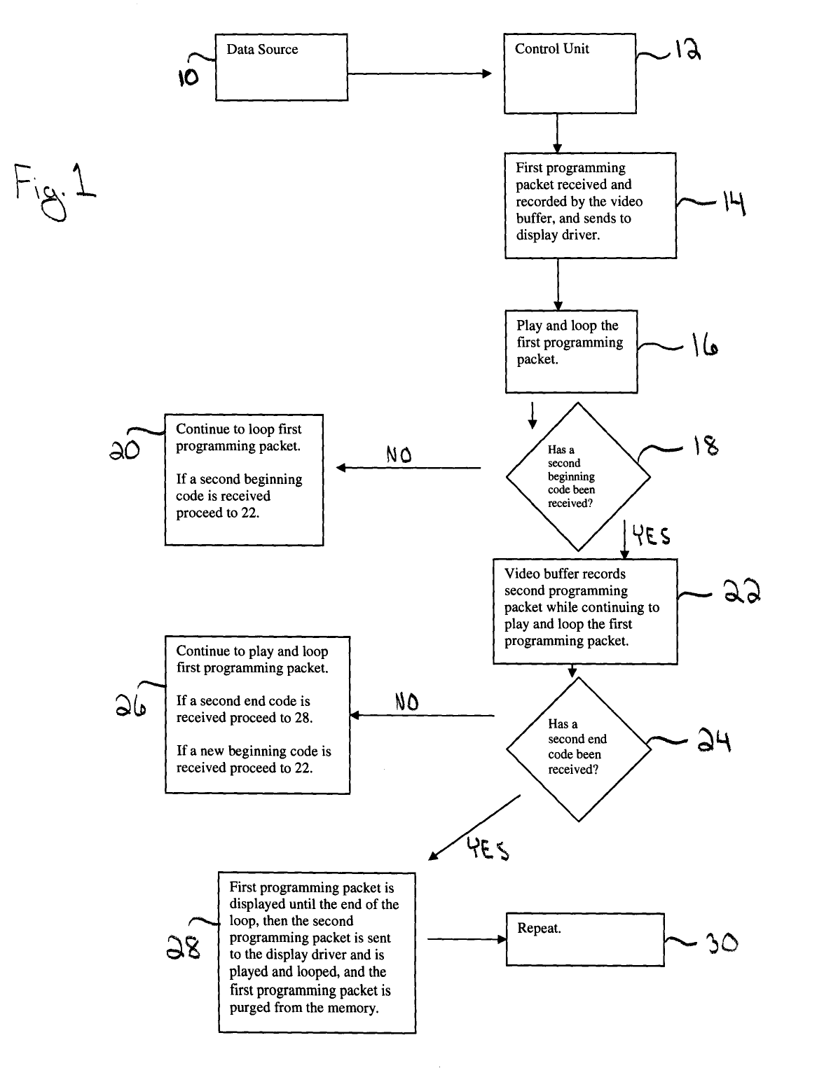

Referring to FIG. 1, a data source 10 is provided. The data source 10 may be located offsite or onsite. The data source 10 may transmit a data stream to an optional control unit 12. The data stream may comprise programming packets. In some embodiments the programming packets may have a defined running time. The running time is defined by an embedded code at the beginning, end, or both beginning and end of each programming packet. The embedded code may provide information related to the defined programming packet, such as length, contents, advertiser name, and/or any other relevant information. A programming packet may also comprise a plurality of different advertisements from a plurality of different advertisers. The advertisements may be commercials, movie previews, or other marketing tools.

Upon receiving the data stream from the data source 10, the optional control unit 12 may perform several tasks. The control unit may be used to embed the codes at either the beginning or end of the programming packets (if this was not done previously). After reading or analyzing the codes and data stream the control unit may then send the programming packets to at least one video buffer. Alternatively, the programming packets may be sent directly from the data source 10 to one or more video buffers. A wired or wireless internet connection may be used to connect the video buffers with the data source 10.

As the video buffer receives the programming packets, the video buffer may read the embedded code at the beginning of each packet. Upon reading this beginning code the video buffer may begin to record and store the programming packet. The programming packet may be stored in an internal memory unit or an external memory unit in communication with the video buffer. When the video buffer receives and recognizes the programming packet end code, the video buffer may send the saved programming packet to a display to be shown to consumers as shown in 14.

The video buffer may be programmed to play the saved programming packet in a continuous loop, as shown in 16. As the video buffer is playing the saved programming packet, the data stream may begin to deliver a new programming packet, as shown in 18. If a new programming packet is not fully received once the display has completed the displaying of the first programming packet, then the video buffer may continue to loop the first programming packet, as shown in 20. If the video buffer receives a new programming packet beginning code in the data stream, the video buffer may begin to record and store the new programming packet into its memory, while continuing to play the first programming packet, as shown in 22.

The video buffer may continue to record the new programming packet, while playing the saved programming packet, until the video buffer records a complete, corruption free, new programming packet. To determine whether a new programming packet has been received the video buffer reads the embedded end code at the end of the programming packet. In the event the data stream has been interrupted and no end code has been received, the video buffer may continue to loop the saved programming packet, as shown in 26. If an end code for the new programming packet is received then the process will continue to step indicated in 28. In addition, the video buffer may utilize data corruption technology to determine if the data in the new programming packet is complete and noncorrupt. If the new programming packet is either incomplete or corrupted the video buffer may either discard the corrupted data or continue recording until it receives either an end code or a second new beginning code. These functions are accomplished while continuing to loop the first programming packet. If a new beginning code is received the process may proceed to the step described in 22.

If the video buffer receives a complete and noncorrupt new programming packet, the first saved programming packet may continue to be displayed until the current loop is completed. After the current loop of the first saved programming packet is completed, the video buffer begins to send the new programming packet to the display, and the original programming packet may purged from its memory, as shown in 28. Alternatively, the first programming packet may be stored in local memory for later access. This process may continue for each new programming packet in the data stream as indicated in 30.

In other exemplary embodiments, the video buffer may be able to discontinue the displaying of the original programming packet between advertisements by using markers which are placed at the beginning and end of the individual advertisements in the programming packet. This would allow the newly saved programming packet to be displayed sooner and may be especially useful where the first programming packet is rather long (i.e. contains several individual advertisements).

By having a complete and corruption free programming packet saved to the video buffer at all times, the display of such programming packets may not be interrupted during data stream interruption or delay. In other embodiments, the video buffer may also store in memory the number of times an individual programming packet or individual advertisement has been played. This may be accomplished by using the beginning and end codes embedded in the programming packet or markers embedded at the beginning and end of each individual advertisement. In other embodiments, the video buffer may only record the number of times a programming packet or advertisement is displayed when a loss or interruption of the data stream has occurred.

The video buffers may be in wired or wireless communication with the control unit. In other embodiments, a control unit may not be used; the data stream may feed directly into the video buffer either through wired or wireless communication. The video buffer may be in wired or wireless communication with a display driver, but preferably is in a local, secure, and wired communication with the display driver.

The embodiments herein disclosed are not intended to be exhaustive or to unnecessarily limit the scope of the invention. The embodiments were chosen and described in order to explain the principles so that others skilled in the art may practice the invention. Having shown and described embodiments, it will be within the ability of one or ordinary skill in the art to make alterations or modifications, such as through the substitution of equivalent materials or structural arrangements, or through the use of equivalent process steps, as to be able to practice the invention without departing from the spirit of the invention. It is the intention, therefore, to limit the invention only as indicated by the scope of the claims.

What is claimed is:

1. A system for continuously displaying data on an electronic display comprising:
a video data source which provides a programming packet having a beginning code;
a video buffer which receives the programming packet from the video data source, stores the programming packet, and transmits the programming packet; and
an electronic display in electrical communication with the video buffer and displaying the programming packet;
wherein the video buffer continuously loops the transmission of the programming packet to the electronic display while simultaneously receiving additional programming packets for transmission.

2. The display system from claim 1 further comprising:
electronic circuitry within the video buffer which extracts data from the beginning codes of the programming packets; and
a local storage device in electrical communication with the video buffer which stores the extracted data.

3. The display system from claim 2 wherein:
the extracted data comprises identification data for one or more advertisers, on whose behalf the programming packet is being transmitted.

4. The display system from claim 3 wherein:
the extracted data further comprises the number of times that the programming packet has been transmitted to the display.

5. The display system from claim 1 further comprising:
a control unit which receives the programming packet from the video data source and distributes the programming packets to at least one video buffer.

6. The display system from claim 5 further comprising:
an internet connection between the control unit and the video data source.

7. The display system from claim 5 further comprising:
a wireless connection between the control unit and the video buffers.

8. The display system from claim 1 further comprising:
a local storage device in electrical communication with the video buffer which stores transmitted programming packets for later access by the video buffer.

9. A system for continuously displaying data on an electronic display comprising:
a video data source which provides programming packets having beginning and ending codes;
one or more video buffers which receive and store a first packet from the video data source and transmit the first packet in a continuous loop while simultaneously receiving and storing a second programming packet, the transmission of the first packet continuing until the ending code for the second packet is received; and
an electronic display in electrical communication with each video buffer, which receives and displays the programming packets.

10. The display system from claim 9 further comprising:
electronic circuitry within each video buffer which extracts data from the beginning and ending codes of the programming packets; and
a local storage device in electrical communication with each video buffer which stores the extracted data.

11. The display system from claim 10 wherein:
the data extracted from the beginning and ending codes of the programming packets comprises identification data for one or more advertisers, on whose behalf the programming packet is being transmitted.

12. The display system from claim 11 wherein:
the data extracted from the beginning and ending codes of the programming packets further comprises the number of times that the packet has been transmitted to the display.

13. The display system from claim 9 further comprising:
a control unit which receives the programming packets from the video data source and distributes the packets to the video buffers.

14. The display system from claim 13 further comprising:
an internet connection between the control unit and the video data source.

15. The display system from claim 13 further comprising:
a wireless connection between the control unit and the video buffers.

16. The display system from claim 9 further comprising:
a local storage device in electrical communication with the video buffer which stores transmitted programming packets for later access by the video buffer.

17. A method for continuously displaying a plurality of programming packets on an electronic display, each programming packet having a beginning code, the method comprising:
(A) transmitting a first programming packet to a video buffer in electrical communication with an electronic display;
(B) receiving and storing the first programming packet at the video buffer until the entire programming packet has been stored;
(C) transmitting the stored first programming packet to an electronic display;
(D) repeating steps (A) and (B) for a second programming packet while repeating step (C) in a substantially continuous loop; and
(E) transmitting the second programming packet to the electronic display.

18. The continuous display method from claim 17 further comprising the steps of:
(F) repeating steps (A) and (B) for a third programming packet while repeating step (E) in a substantially continuous loop; and
(G) transmitting the third programming packet to the electronic display

19. The continuous display method from claim 17 further comprising the steps of:
analyzing the programming packets for proper format and lack of corruption prior to transmitting the packets to the electronic display.

20. The continuous display method from claim 17 further comprising the step of:
(F) purging the first programming packet from the video buffer after beginning step (E).
